(19) United States
(12) Patent Application Publication
(10) Pub. No.: US 2018/0142652 A1
(43) Pub. Date: May 24, 2018

(54) MUFFLING APPARATUS

(71) Applicant: ROKI CO., LTD., Hamamatsu-Shi (JP)

(72) Inventors: Cuong NGUYEN HUNG, Hamamatsu-Shi (JP); Shuhei SEI, Hamamatsu-Shi (JP)

(73) Assignee: ROKI CO., LTD., Hamamatsu-Shi (JP)

(21) Appl. No.: 15/723,533

(22) Filed: Oct. 3, 2017

(30) Foreign Application Priority Data
Nov. 18, 2016 (JP) 2016-225180

(51) Int. Cl. F02M 35/12

(52) U.S. Cl. CPC F02M 35/1255; F02M 35/1205

(57) ABSTRACT

There is provided a muffling apparatus capable of sufficiently reducing noise, achieving space saving, and suppressing an increase in air-flow resistance in a suction passage. In a muffling apparatus including a resonator main body having a predetermined volume and a communication tube that allows the resonator main body to communicate with a suction passage of an internal combustion engine, the communication tube includes a first communication tube having one end that communicates with the suction passage, a second communication tube having one end that communicates with the resonator main body, and a continuous section that communicates with other ends of the first and second communication tubes, and a third communication tube is formed at the continuous section.

### BACKGROUND OF THE INVENTION

### Field of the Invention

The present invention relates to a muffling apparatus, and particularly to a muffling apparatus that is provided at a suction passage of an internal combustion engine and reduces suction noise.

### Description of the Related Art

It is known that when an internal combustion engine is driven so that a suction valve opens and closes, pulsation noise is produced and forms suction noise. To reduce the suction noise, there is a known muffling apparatus having, for example, of a resonator or a side-branch-type resonator (hereinafter referred to as “side branch”) so formed as to be continuous with the suction passage.

A resonator 110 includes a resonator main body 110a, which has a predetermined volume, and a communication tube 111, which bifurcates from a suction passage 112 and allows the suction passage 112 to communicate with the resonator main body 110a, as shown in FIG. 3, and a volume of the resonator main body 110a is so specified that noise at a frequency calculated based, for example, on Helmholtz's resonance theory is reduced.

A side branch 120 is a tubular body with a bottomed part having a predetermined uniform cross section and bifurcates from the suction passage 112. A total length of the side branch 120 is specified as appropriate in accordance with a frequency of noise to be reduced.

It is known that noise produced in the suction passage that communicates with an internal combustion engine is suction noise resulting from an air intermittent flow produced by suction of air when the suction valve is opened. The suction noise contains noise at a variety of frequencies, and to attenuate suction noise at a specific frequency that can be harsh noise, the volume of the resonator described above and the length of the side branch described above are adjusted as appropriate, and the thus adjusted resonator and side branch are disposed so as to bifurcate from the suction passage. A variety of forms of such a muffling apparatus have been known.

The muffling apparatus described in Japanese Patent Laid-Open No. 11-294278 includes a plurality of mufflers, and among the plurality of mufflers, a first muffler has a resonant chamber the extends in a lengthwise direction of a suction passage and in a direction perpendicular to the lengthwise direction, and a second muffler is disposed in the resonant chamber and has an expansion chamber. A communication port of the suction passage in the resonant chamber and a communication port of the suction passage in the expansion chamber are arranged side by side along the lengthwise direction of the suction passage. At least a portion that forms the first muffler and includes the communication port of the suction passage in the resonant chamber, a portion that forms the second muffler and includes the communication port of the suction passage in the expansion chamber, and the suction passage are formed integrally with one another in integral molding.

The muffling apparatus described in Japanese Patent Laid-Open No. 2008-133771 includes a resonant chamber formed of a space surrounded by not only a suction passage forming wall that forms part of a suction passage but a shielding wall that shields the space from the atmosphere, a Helmholtz-type muffler including a communication tube so provided that a communication tube that allows an interior of the suction passage to communicate with the resonant chamber is extended from the suction passage forming wall into the resonant chamber, and a side-branch-type muffler formed of a bottomed tubular wall that protrudes from the suction passage forming wall into the resonant chamber, and the muffling apparatus is formed of first, second, and third pieces formed separately from one another and then integrated with one another. The suction passage forming wall, a portion of the shielding wall, at least a portion of the communication tube, and a portion of the bottomed tubular wall are formed as the first piece, another portion different from the above-mentioned portion of the shielding wall, a portion other than the above-mentioned portion of the communication tube in the case where only the above-mentioned portion of the communication tube is formed as the first piece, and a portion other than the above-mentioned portion of the bottomed tubular wall are formed as the second piece, and a portion other than the above-mentioned portion of the shielding wall is formed as the third piece.

The muffling apparatus described in Japanese Patent Laid-Open No. 2009-36185 is a muffling apparatus used with an internal combustion engine and including a hollow portion that forms a space that communicates with an interior of a suction/exhaust tube of the internal combustion engine and provides a muffling function based on resonance, and a volume varying device that makes a volume of the hollow portion variable is provided.

### SUMMARY OF THE INVENTION

According to the configurations of the muffling apparatus of related art described above, however, since a resonator and a side branch are both required so that a structure in which the resonator and the side branch bifurcate from the suction passage is employed, a space in which these members are disposed needs to be provided in the vicinity of the suction passage. Further, to attenuate noise at a specific frequency, it is necessary to ensure a certain volume of the resonator main body and a certain length of the side branch, undesirably resulting in an extreme difficulty in arranging these members in an engine room, which is required to be compact for space saving. Further, since the structure in which a plurality of members bifurcate from the suction passage is employed, holes are formed in an inner wall of the suction passage and at locations where the members bifurcate therefrom, undesirably resulting in air turbulence due to the holes. Since the air turbulence results in an increase in air-flow resistance, it is undesirably difficult to suppress the air-flow resistance.

The present invention has been made in view of the problems described above, and an object of the present invention is to provide a muffling apparatus capable of sufficiently reducing noise, achieving space saving, and suppressing an increase in air-flow resistance in a suction passage.

A muffling apparatus according to the present invention includes a resonator main body having a predetermined volume and a communication tube that allows the resonator main body to communicate with a suction passage of an internal combustion engine. The communication tube includes a first communication tube having one end that communicates with the suction passage, a second communication tube having one end that communicates with the resonator main body, and a continuous section that communicates with other ends of the first and second communication tubes, and a third communication tube is formed at the continuous section.

In the muffling apparatus according to the present invention, the first and second communication tubes are preferably disposed so as to be perpendicular to each other via the continuous section.

In the muffling apparatus according to the present invention, the third communication tube preferably extends in a direction opposite a direction in which the first communication tube extends.

In the muffling apparatus according to the present invention, noise at least at a first effect frequency F1, a second effect frequency F2, and a third effect frequency F3, which are derived from a following expression, is preferably muffled, where L1 represents a length of the first communication tube, L2 represents a length of the second communication tube, L3 represents a length of the third communication tube, and L4 represents a length of the continuous section,

$$F 1 = \frac{c}{2 π} \sqrt{\frac{S}{V \cdot ( L 1 + L 2 + L 4 )}} \\ F 2 = \frac{c}{2 ( L 1 + L 2 + L 4 ) + 3 L 3} \\ F 3 = 2 F 2 \qquad [ Expression 1 ]$$

in Expression 1, c represents a sound speed at room temperature, S represents a cross-sectional area of the communication tube, and V represents a volume of the resonator main body.

The above-mentioned summary of the present invention is not intended to list all features necessary for the present invention, and a sub-combination of a group of the features can also be a claim of the invention.

The muffling apparatus according to the present invention includes the continuous section, which communicates with the other ends of the first and second communication tubes, and the third communication tube is formed at the continuous section, whereby noise at a plurality of frequencies can be attenuated for sufficient reduction in noise, and an increase in air-flow resistance can be suppressed at the same time because it is not necessary to form a plurality of holes in the inner wall of the suction passage. Further, space saving is achieved.

### BRIEF DESCRIPTION OF THE DRAWINGS

FIG. 1 is an overview of a muffling apparatus according to an embodiment of the present invention;

FIG. 2 is graphs for describing a muffling effect provided by the muffling apparatus according to the present embodiment; and

FIG. 3 is an overview of a muffling apparatus of related art.

### DETAILED DESCRIPTION OF THE PREFERRED EMBODIMENTS

A preferable embodiment for implementing the present invention will be described below with reference to the drawings. It is noted that the following embodiment is not intended to limit the invention according to each claim, and all combinations of features described in the embodiment are not necessarily essential for a solution of the present invention.

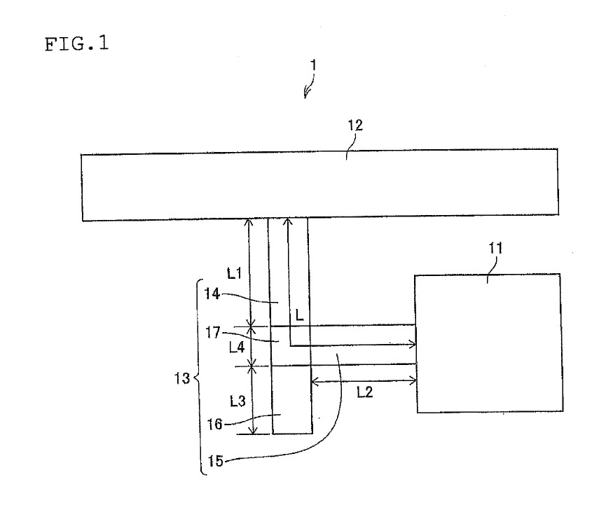

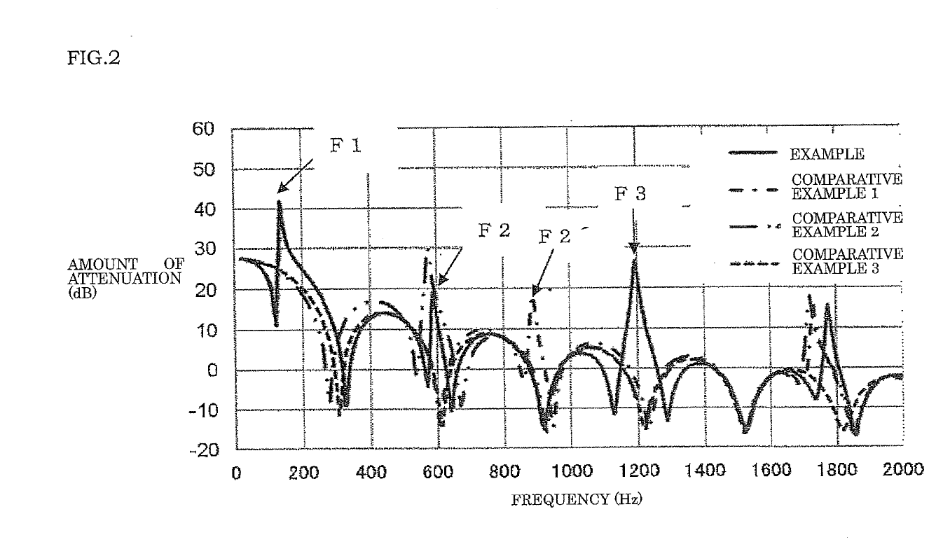

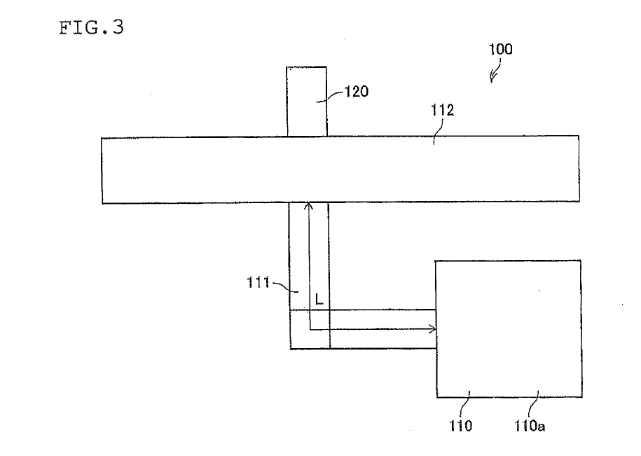

FIG. 1 describes an overview of a muffling apparatus according to the present embodiment. FIG. 2 shows graphs for describing a muffling effect provided by the muffling apparatus according to the present embodiment. FIG. 3 describes an overview of a muffling apparatus of related art.

A muffling apparatus 1 according to the present embodiment is attached to a suction passage 12 for introducing filtered outside air, which has undergone a filtering process in which an air cleaner that is not shown filters out dust and other undesirable objects contained in the outside air, into an internal combustion engine, as shown in FIG. 1. The suction passage 12 is a tubular member so formed that an inner wall thereof is smoothened, and a variety of cross-sectional shapes of the suction passage 12 have been known, such as a circular shape, an elliptical shape, and a polygonal shape.

The muffling apparatus 1 according to the present embodiment includes a resonator main body 11, which has a predetermined volume, and a communication tube 13, which allows the resonator main body 11 to communicate with the suction passage 12. The resonator main body 11 can be formed in any of a variety of shapes, such as a box-like shape and a cylindrical shape, and the volume of the resonator main body 11 is determined based on Helmholtz's resonance theory and in accordance with a frequency at which noise is attenuated.

The communication tube 13 includes a first communication tube 14, which has one end that bifurcates from the suction passage 12, a second communication tube 15, which has one end that communicates with the resonator main body 11, and a continuous section 17, which is continuous with other ends of the first communication tube 14 and the second communication tube 15. The first communication tube 14 and the second communication tube 15 are disposed so as to be roughly perpendicular to each other via the continuous section 17.

The communication tube 13 further includes a third communication tube 16, which is formed at the continuous section 17. The third communication tube 16 can extend in any direction as long as the third communication tube 16 is so formed as to be continuous with the continuous section 17. For example, the third communication tube 16 preferably extends in a direction opposite a direction in which the first communication tube 14 extends.

The communication tube 13 is a tubular member having a roughly fixed cross-sectional area that is formed to be smaller than the cross-sectional areas of the suction passage 12 and the resonator main body 11. Further, the first communication tube 14, the second communication tube 15, the third communication tube 16, and the continuous section 17 have roughly the same cross-sectional area and each have a smooth inner wall.

The communication tube 13 and the resonator main body 11 may be made of any material and are preferably made, for example, of a synthetic resin. For example, a polypropylene-based resin, a polyamide-based resin, or any other thermoplastic synthetic resin is preferably used. Further, the communication tube 13 and the resonator main body 11 may be formed integrally with each other, or the communication tube 13 and the resonator main body 11 may be formed separately from each other and then combined with each other with a known joining device. Similarly, as for the communication tube 13, the first communication tube 14, the second communication tube 15, the third communication tube 16, and the continuous section 17 may be formed integrally with one another, or these members may be formed separately from one another and then combined with one another as appropriate.

The thus formed muffling apparatus 1 according to the present embodiment can muffle noise at first to third effect frequencies F1, F2, and F3, which can be derived from the following expression, where L1, L2, L3, and L4 (mm) represent the lengths of the first communication tube 14, the second communication tube 15, the third communication tube 16, and the continuous section 17.

$$F 1 = \frac{c}{2 π} \sqrt{\frac{S}{V \cdot ( L 1 + L 2 + L 4 )}} \\ F 2 = \frac{c}{2 ( L 1 + L 2 + L 4 ) + 3 L 3} \\ F 3 = 2 F 2 \qquad [ Expression 2 ]$$

In Expression 2, c represents the sound speed (m/s) at room temperature, S represents the cross-sectional area (mm²) of the communication tube 13, and V represents the volume (L) of the resonator main body 11.

In the muffling apparatus 1 according to the present embodiment, since the communication tube 13, which bifurcates from the suction passage 12 is a single communication tube, the number of holes formed in the inner wall of the suction passage 12 in association with the installation of the muffling apparatus 1 can be reduced, whereby an increase in air-flow resistance in association with an increase in the number of holes can be suppressed.

In comparison of the amount of attenuation in Example of the muffling apparatus 1 according to the present embodiment with the amount of attenuation in Comparative Examples 1 to 3 having the configurations of related art, significant amounts of attenuation of noise can be ascertained at the first effect frequency F1, where attenuation is also achieved in Comparative Example 1, as well as at the second and third effect frequencies F2, F3, as shown in FIG. 2. The first to third effect frequencies F1, F2, and F3 can be adjusted as appropriate by using the expression described above.

In contrast, an effect frequency F2′, where the attenuation effect has been ascertained in Comparative Example 1, results from an effect of the communication tube of the resonator, and is therefore a secondary effect in addition to the purpose of reduction in noise at the effect frequency F1 provided by a design method of related art, and is an effect frequency that cannot be directly controlled. On the other hand, the muffling apparatus 1 according to the present embodiment can be so designed that the second effect frequency F2 is also a frequency where the noise is reduced. Further, FIG. 2 shows comparison of the amount of attenuation among Example and Comparative Examples 1 to 3, and a greater the amount of attenuation along the vertical axis is taken to be a higher attenuation effect.

Comparative Examples 1 to 3 described above were carried out as follows: In Comparative Example 1, the amount of attenuation in a form in which a resonator is attached to a suction passage via a communication tube is measured; in Comparative Example 2, the amount of attenuation in a form in which a side branch is attached to the suction passage is measured; and in Comparative Example 3, the amount of attenuation in a form in which only the suction passage is present is measured.

As described above, the muffling apparatus 1 according to the present embodiment includes the continuous section, which communicates with the other ends of the first and second communication tubes, and the third communication tube is formed at the continuous section, whereby noise at a plurality of frequencies can be attenuated for sufficient reduction in noise, and space saving can be achieved at the same time. Further, an increase in air-flow resistance in the suction passage can be suppressed by suppression of the number of communication tubes that bifurcate from the suction passage.

The present embodiment has been described with reference to the case where the third communication tube 16 is so formed as to extend in the direction opposite the direction in which the first communication tube 14 extends. Instead, the third communication tube 16 may be so formed as to extend in the direction opposite the direction in which the second communication tube 15 extends. It is apparent from the description of the claims that a form in which such a change or improvement is made also falls within the technical scope of the present invention.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

The entire disclosure of Japanese Patent Application No. 2016-225180 filed on Nov. 18, 2016 including the specification, claims, drawings and summary is incorporated herein by reference in its entirety.

### REFERENCE SIGNS LIST

1 Muffling apparatus, 11, 110a Resonator main body,
   12, 112 Suction passage, 13, 111 Communication tube, 14 First communication tube, 15 Second communication tube, 16 Third communication tube, 17
   Continuous section, 110 Resonator, 120 Side branch

1. A muffling apparatus comprising:
a resonator main body having a predetermined volume; and
a communication tube that allows the resonator main body to communicate with a suction passage of an internal combustion engine,
wherein the communication tube includes a first communication tube having one end that communicates with the suction passage, a second communication tube having one end that communicates with the resonator main body, and a continuous section that communicates with other ends of the first and second communication tubes, and
a third communication tube is formed at the continuous section.

2. The muffling apparatus according to claim 1,
wherein the first and second communication tubes are disposed so as to be perpendicular to each other via the continuous section.

3. The muffling apparatus according to claim 1,
wherein the third communication tube extends in a direction opposite a direction in which the first communication tube extends.

4. The muffling apparatus according to claim 1,
wherein noise at least at a first effect frequency F1, a second effect frequency F2, and a third effect frequency F3, which are derived from a following expression, is muffled, where L1 represents a length of the first communication tube, L2 represents a length of the second communication tube, L3 represents a length of the third communication tube, and L4 represents a length of the continuous section,
$$F 1 = \frac{c}{2 π} \sqrt{\frac{S}{V \cdot ( L 1 + L 2 + L 4 )}} \\ F 2 = \frac{c}{2 ( L 1 + L 2 + L 4 ) + 3 L 3} \\ F 3 = 2 F 2 \qquad [ Expression 1 ]$$
in Expression 1, c represents a sound speed at room temperature, S represents a cross-sectional area of the communication tube, and V represents a volume of the resonator main body.
